(19) United States
(12) Patent Application Publication
(10) Pub. No.: US 2008/0127797 A1
(43) Pub. Date: Jun. 5, 2008

(54) HOLE PUNCH

(75) Inventor: Zeng Xu HUI, Huizhou City (CN)

Correspondence Address: PILLSBURY WINTHROP SHAW PITTMAN, LLP, P.O. BOX 10500, MCLEAN, VA, 22102, US

(73) Assignee: Helix Limited, Stourbridge (GB)

(21) Appl. No.: 11/948,207

(22) Filed: Nov. 30, 2007

(30) Foreign Application Priority Data
Nov. 30, 2006 (CN) 200620160151.4
Aug. 31, 2007 (GB) 01716919.5

(51) Int. Cl. B26D 1/12

(52) U.S. Cl. 83/669

(57) ABSTRACT

A hole punch comprising a movable punch pin arranged to punch a hole in a material. The hole punch comprises a first lever pivotally attached to a base, and in communication with the punch pin. The hole punch also includes a second lever pivotally attached to the first lever, and a third lever pivotally attached to the base, and pivotally attached to the second lever. Rotation of the third lever is arranged to drive movement of the second lever and first lever to cause movement of the punch pin.

### CROSS REFERENCE TO RELATED APPLICATIONS

This application claims priority to British patent application no. 0716910.5, filed Aug. 31, 2007 and to Chinese application no 200620160151.4, filed Nov. 30, 2006, the entire contents of both of which are incorporated by reference in their entirety.

### FIELD OF THE INVENTION

The present invention relates to hole punches, particularly but not exclusively of the type for punching holes in sheets of paper. The invention also encompasses hole punches for other materials, e.g. metals or plastics. The invention covers one, two, three, four, or other multiple hole punches.

### SUMMARY OF THE INVENTION

According to a first aspect of the present invention there is provided a hole punch as claimed in claim 1.

Lever effects are utilised to provide a more efficient hole punching mechanism relative to existing single lever hole punches.

Embodiments of the present invention will now be described, by way of example only, with reference to the accompanying drawings.

### BRIEF DESCRIPTION OF THE DRAWINGS

FIGS. 1 and 2 show a side and an end view respectively of part of a hole punch according to an embodiment of this invention; and

FIGS. 3 and 4 show a side view and an end view respectively of the hole punch of FIGS. 1 and 2 when it is fully assembled.

### DETAILED DESCRIPTION OF THE ILLUSTRATED EMBODIMENT(S) OF THE INVENTION

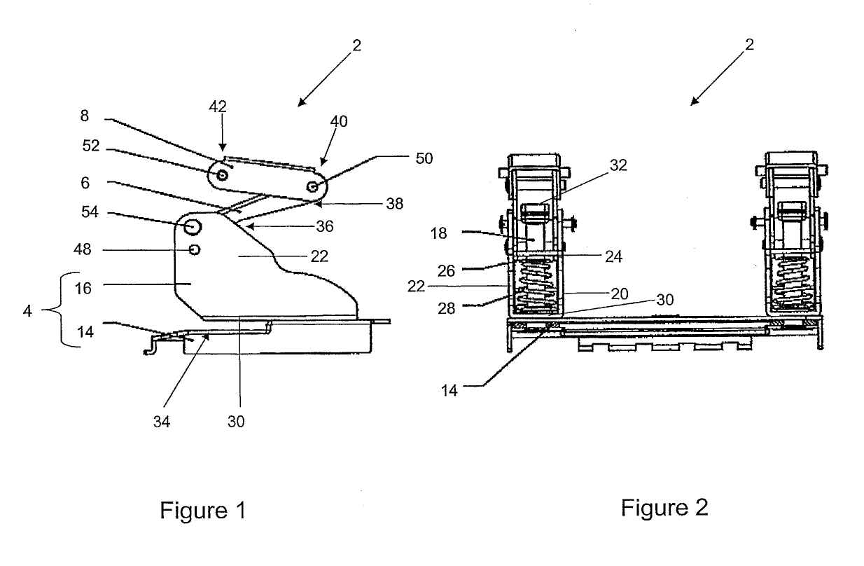

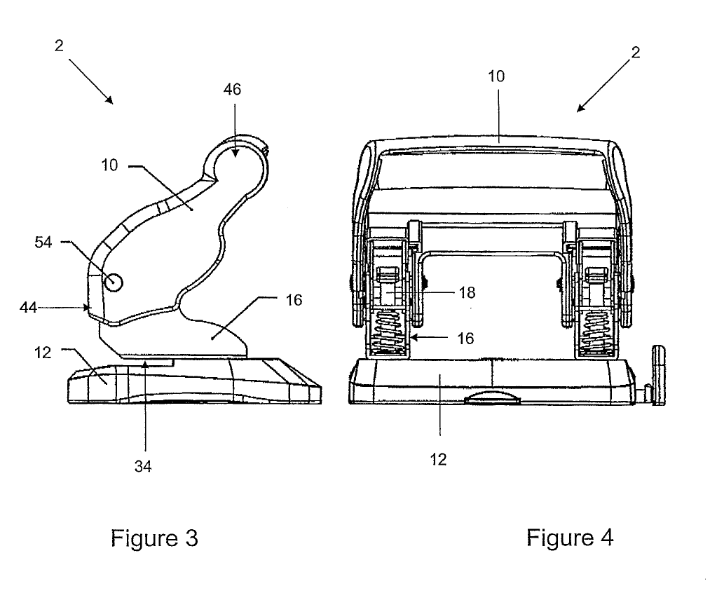

FIGS. 1 to 4 show a hole punch 2 according to an embodiment of this invention. The hole punch 2 is a two-hole punch for punching holes in sheets of paper or stacks of sheets of paper. The invention is applicable in other embodiments to hole punches for punching single holes, three holes, four holes, five holes, or other multiple numbers of holes in any suitable material, such as paper, plastic or metal.

The hole punch 2 includes a base 4, a first lever 6 which is pivotally mounted to the base 4, a second lever 8 which is pivotally mounted to the first lever 6, and a third lever 10, in the form of a plastic handle, pivotally mounted to the base 4 and to the second lever 8.

FIGS. 1 and 2 show the hole punch 2 with the third lever 10 removed so that the other levers can be clearly seen. Part of the base 4 is also not shown in FIGS. 1 and 2. From FIGS. 2 and 4 it is apparent that the hole punch 2 comprises a substantially symmetrical form comprising two similar punch mechanisms and, for clarity, only one of the two punch mechanisms will be described in detail—the other of the punch mechanisms being substantially identical in its form.

The base 4 comprises a lower plastic cover 12, which covers a metal base plate 14. The base 4 also comprises two punch pin housings 16. The hole punch 2 also includes two punch pins 18—each punch pin 18 is located within its corresponding punch pin housing 16. The metal base plate 14 includes punch pin apertures (not shown) directly beneath each punch pin 18. The punch pin apertures correspond in size to the diameter of the punch pins 18. The punch pin housing 16 comprises, in cross section, a U-shaped channel which is bolted to the base plate 14. The punch pin housing 16 includes a first upstanding wall 20 and a second upstanding wall 22. From the first upstanding wall 20, there extends a punch pin locating plate 24 at about 90° to the upstanding wall 20. The punch pin locating plate 24 includes a punch pin alignment hole (not shown) which corresponds in shape and is slightly larger in size than the punch pin 18 such that the punch pin is able to freely slide through the hole in use.

The punch pin 18 comprises a flanged portion 26 which is located beneath the punch pin locating plate 24 in use. The flanged portion 26 is too large to pass through the punch pin locating hole and so limits the extent to which the punch pin can move upwards.

A compression spring 28 is located between a base 30 of the punch pin housing and the flanged portion 26 of the punch pin 18. The compression spring 28 thus urges the punch pin 18 upwards—the equilibrium position of the punch pin is therefore the position in which the flanged portion 26 abuts against the punch pin locating plate 24.

In this embodiment the punch pin comprises a flat topped pinhead 32. The punch pin 18 is able to slide vertically in this embodiment. At the vertical position at which the punch pin 18 is located, the base of the punch pin housing 30 comprises a punch pin aperture arranged to allow the punch pin to pass through it. At the same vertical position in the metal base plate 14 there is a punch pin aperture as previously mentioned. There is a space between the base of the punch pin housing 30 and the metal base plate 14 at this punch pin location in order to allow a material which is to be hole-punched to be placed therein. In this embodiment the hole punch 2 is arranged to receive about 30 sheets of paper within this space. This space is known as the punching region 34 since the punch pin 18 must pass through it in order to perform the operation of hole-punching.

The punch pin 18 is a conventional punch pin and includes a cutting surface at its bottom end.

The first, second, and third levers 6, 8, 10 are formed as U-shaped channels having horizontal cross-sections and downwardly extending side walls. The side walls include apertures to receive pivot pins at their pivot locations. The first lever has a first end 36 and a second opposite end 38. The second lever has a first end 40 and a second opposite end 42. The third lever has a first end 44 and a second opposite end 46.

The first end 36 of the first lever 6 is pivotally mounted to the base 4 (in this embodiment, to the punch pin housing 16) at a first pivot point 48. The second end 38 of the first lever 6 is pivotally mounted to the first end 40 of the second lever 8 at a second pivot point 50. The second end 42 of the second lever 8 is pivotally mounted to the third lever 10 at a third pivot point 52. The third pivot point 52 is located between the first end 44 and the second end 46 of the third lever 10. The third pivot point 52 is closer to the first end 44 of the third lever 10 than the second end 46. The first end 44 of the third lever 10 is pivotally mounted to the base 4 (in this embodiment, to the punch pin housing 16) at a fourth pivot point 54.

Although it is not shown in this embodiment, there may be a bearing projection provided on an undersurface of the second lever 8. This bearing projection is positioned so that it contacts the top of the punch pin 18—in the punch pin of this embodiment it contacts the flat topped pinhead 32. The bearing projection in some embodiments comprises a short cylindrical projection having a rounded edge. The rounded edge allows smooth contact between the projection and the top of the punch pin throughout the range of movement of the punch pin relative to the second lever (and thus the bearing projection) in use.

In use, a user wishing to punch holes in a sheet of paper positions the sheet of paper within the punching region 34. The handle (the third lever) 10 is then pressed manually. The handle is usually pressed at or near the second end 46 to gain more lever advantage since the second end 46 is more spaced from the third and fourth pivot points 52, 54 than the other parts of the third lever 10.

Conventional hole punches use a punch pin and single lever arrangements, whereby a single lever is pivoted to a base and contacts a punch pin which is forced down through sheets of paper to the hole punch. Advantageously, the hole punch 2 of this invention gains mechanical advantage through its extra lever arrangement. In some cases, about 50% less force is required to punch through the same number of sheets of paper using a hole punch of a similar handle size according to this invention than with a conventional hole punch of the same handle size. Accordingly in some embodiments, cleaner hole punching is provided—especially where many sheets of paper (or other material) need to be punched at once. In general the present invention provides a more compact hole punch since a shorter handle can provide a similar hole-punching force to a relatively longer handle of a conventional single lever hole punch.

In the disclosed embodiment, the hole punch 2 has first and fourth pivot points 48, 54 which are close to each other. In this embodiment they are substantially adjacent each other. In other embodiments they may be more spaced apart.

In yet further embodiments, the pivot points may not be entirely fixed—the pivot pins may be provided in channels having a width equivalent to the diameter of a pivot pin, thereby allowing some sliding of the pivot pin, if required.

Other combinations of lever length, lever shape, lever spacing, pivot point spacing will be apparent through routine experimentation to the skilled person. It is also possible to provide more than three levers, possibly to gain further mechanical advantage.

1. A hole punch comprising
a movable punch pin arranged to punch a hole in a material,
a first lever,
a second lever,
a third lever,
a base,
the first lever being pivotally attached to the base and in communication with the movable punch pin,
the second lever pivotally attached to the first lever, the third lever pivotally attached to the base and pivotally attached to the second lever, wherein rotation of the third lever is arranged to drive movement of the second lever and first lever to cause movement of the punch pin.

2. The hole punch of claim 1 comprising a punching region, wherein the punch pin is arranged to move from a pre-punch position through the punching region in which the material is located in use.

3. The hole punch of claim 2, wherein when the punch pin is in the pre-punch position, the angle between the first lever and the second lever is less than 90°.

4. The hole punch of claim 3, wherein the angle is less than 45°.

5. The hole punch of claim 2, wherein the punch pin is urged to the pre-punch position.

6. The hole punch of claim 1 wherein the base is integrally formed.

7. The hole punch of claim 1, wherein the base comprises separate parts and the pivot point between the third lever and the base is on a different part to the pivot point between the first lever and the base.

8. The hole punch of claim 1 wherein the pivot point between the third lever and the base is close or adjacent to the pivot point between the first lever and the base.

9. The hole punch of claim 1 wherein the first lever comprises a bearing surface arranged to contact the punch pin.

10. The hole punch of claim 9 comprises a rounded projection extending from the first lever and wherein the bearing surface is provided on the rounded projection.

11. The hole punch of claim 1 where the third lever is a handle.

12. The hole punch of claim 1 comprising a one-hole punch, a two-hole punch, a three-hole punch, a four-hole punch or any other multiple hole punch.

13. The hole punch of claim 1 wherein the first lever comprises a first end and an opposite, second end, the second lever comprises a first end and an opposite, second end, the third lever comprises a first end and an opposite, second end, wherein the first end of the first lever is attached to the base, the second end of the first lever is attached to the first end of the second lever, the second end of the second lever is attached to an intermediate point of the third lever between its first and second ends and the first end of the third lever is attached to the base.

14. The hole punch of claim 13, wherein the intermediate point is closer to the first end than to the second end of the of the third lever.
